(19) United States
(12) Patent Application Publication
(10) Pub. No.: US 2016/0089768 A1
(43) Pub. Date: Mar. 31, 2016

(54) OPENING IMPLEMENT FOR ACCESSORY CLASP

(71) Applicant: Japan Landcare Technologies Co., Ltd., Tokyo (JP)

(72) Inventor: Masako Kimura, Tokyo (JP)

(21) Appl. No.: 14/953,609

(22) Filed: Nov. 30, 2015

Related U.S. Application Data
(63) Continuation of application No. PCT/JP2014/064759, filed on Jun. 3, 2014.

(30) Foreign Application Priority Data
Jun. 3, 2013 (JP) 2013-003494

(51) Int. Cl. B25B 7/02; A44B 13/02

(52) U.S. Cl. CPC B25B 7/02; A44B 13/02

(57) ABSTRACT

There is provided an opening implement for a ring-shaped clasp of an accessory, the clasp including: a body having a cutout part, a closing member to close the cutout part, a movable part connected to the closing member to open and close the closing member, and a fixed part. The opening implement includes a first holding part to hold the fixed part, a second holding part configured to hold the movable part; and a connection part connecting the first holding part and the second holding part. The first holding part includes a housing part configured to house any of a part of the spring clasp and a part of the lobster clasp. Any of the spring clasp and the lobster clasp is held by only the first holding part via the housing part.

This application is a Continuation Application of International Application No. PCT/JP2014/064759 claiming the conventional priority of Japanese Utility-Model Application No. 2013-003494 filed on Jun. 3, 2013. The disclosures of Japanese Utility-Model Application No. 2013-003494 and International Application No. PCT/JP2014/064759 are incorporated herein by reference in their entirety.

### TECHNICAL FIELD

The present disclosure relates to an opening implement for a catch (clasp) of an accessory that opens the clasp of the accessory easily.

### BACKGROUND ART

As the opening implements for catches or clasps, such as spring clasps and lobster clasps, of accessories, those being made of metal or wood to have small tweezer-like shapes have been conventionally used.

### SUMMARY

The clasps of accessories are very small. Thus, it is very difficult to pick up the clasp between fingers, and relatively large force is required for the fingers to open the clasp. This means that opening such a clasp is not easy and burdensome, for example, for long-nailed women, and especially for elderly people whose finger-tip strengths are low. An object of the present disclosure is to solve the problems as described above.

According to a first aspect of the present disclosure, there is provided an opening implement for a ring-shaped clasp of an accessory, the clasp including: a body having a cutout part which allows a part of a linear accessory, to be used by being put around a part of a human body, to pass; a closing member configured to close the cutout part; a movable part connected to the closing member to open and close the closing member; and a fixed part through which another part of the linear accessory is passed. The opening implement includes: a first holding part configured to hold the fixed part; a second holding part configured to hold the movable part; and a connecting part connecting the first holding part and the second holding part so that the second holding part is movable relative to the first holding part. The movable part held by the second holding part and the fixed part held by the first holding part are allowed to come close to each other to open the ring-shaped clasp of the accessory. The ring-shaped clasp of the accessory is a spring clasp or a lobster clasp. The first holding part includes a housing part configured to house any of a part of the spring clasp and a part of the lobster clasp. Any of the spring clasp and the lobster clasp is held by only the first holding part via the housing part.

### BRIEF DESCRIPTION OF DRAWINGS

FIG. 1 is a perspective view of an overall structure of an opening implement according to an embodiment of the present disclosure.

FIG. 2 is a plan view of a lower movable wing of the opening implement.

FIG. 3 is a bottom view of an upper movable wing of the opening implement.

FIG. 4 is a side view of the opening implement according to the embodiment of the present disclosure.

FIG. 5 is a front view of the opening implement according to the embodiment of the present disclosure.

FIG. 6 is an illustrative view illustrating a situation in which the opening implement holds a clasp.

FIG. 7 is a cross-sectional view taken along the line VII-VII in FIG. 3 and depicts a cross-section of the upper movable wing.

FIG. 8 schematically depicts a lobster clasp.

FIGS. 9A, 9B, 9C, 9D, 9E, 9F, 9G, 9H, and 9I are front views each depicting modified example of a holding end of the lower movable wing.

FIGS. 10A, 10B, 10C, 10D, 10E, 10F, 10G, 10H and 10I are front views each depicting modified example of a holding. end of the upper movable wing.

FIG. 11 is a perspective view of an opening implement according to another embodiment of the present disclosure.

FIG. 12A is an illustrative view illustrating. connection between a spring clasp and a round jumpring, and FIG. 12B is an illustrative view illustrating connection between the lobster clasp and the round jumpring.

FIGS. 13A and 13B are illustrative views each illustrating a situation in which the opening implement according to the another embodiment of the present disclosure opens the spring clasp.

FIG. 14 is a perspective view of an opening implement according to still another embodiment of the present disclosure.

### DESCRIPTION OF EMBODIMENTS

### First Embodiment

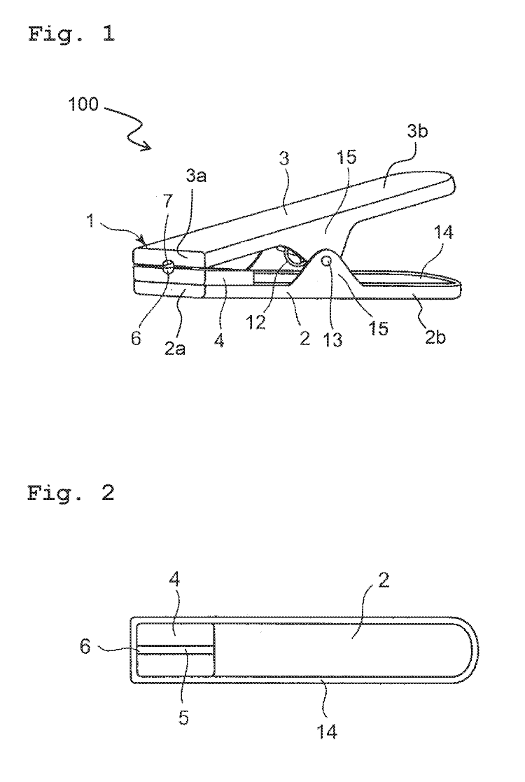

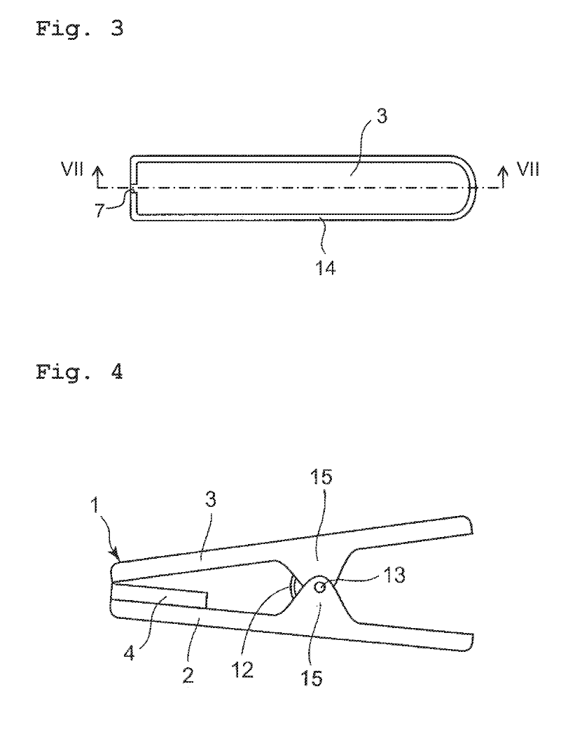

At first, how to use the first embodiment of the present disclosure will be explained below. An opening implement body 1 of an opening implement 100 according to the first embodiment is configured in such a manner that a lower movable wing 2 disposed on a lower side and an upper movable wing 3 disposed on an upper side are pivotably or movably attached to a rotary shaft 13 via their connection parts 15. The connection part 15 protruding from the lower movable wing 2 faces the connection part 15 protruding from the upper movable wing 3. An elastic body 4 is attached to a part of an end of the lower movable wing 2. In the elastic body 4, it is formed a recessed groove 5 extending in the longitudinal direction of the elastic body 4 and a lower recessed hole 6 at the end (FIG. 2). On a peripheral edge 14 provided at an end of the upper movable wing 3, it is formed an upper recessed hole 7 at a position corresponding to the lower recessed hole 6 (FIG. 3). The opening implement 100 according to the first embodiment is used as follows. Namely, a part of the holding end 2a of the lower movable wing 2 is engaged with a fixed part 11 of a clasp 8 and a part of the holding end 3a of the upper movable wing 3 is engaged with a movable part 10 of the clasp 8. In this state, the holding ends 2a, 3a of the lower and upper movable wings 2, 3 are moved to come closer to each other, thereby bringing the movable part 10 and the fixed part 11 close to each other. This moves a movable shaft 9 to open the clasp 8.

The first embodiment of the present disclosure will be explained with reference to the drawings. As depicted in the figure, the opening implement body 1 for a clasp of a necklace is configured as follows. Namely, the lower movable wing 2 and the upper movable wing 3 disposed to face each other are pivotably attached to the rotary shaft 13 via the connection parts 15 so that the lower movable wing 2 and the upper movable wing 3 are openable and closable. The opening implement body 1 includes a spring 12 around the rotary shaft 13 to restore the opening implement body 1 to an original posture. The lower movable wing 2 has a holding end 2a at one side in its longitudinal direction (left-right direction in FIG. 1) and a handle 2b at the other side in the longitudinal direction. The rotary shaft 13 and the spring 12 are disposed between the holding end 2a and the handle 2b. The upper movable wing 3 is provided separately from the lower movable wing 2. The upper movable wing 3 has a holding end 3a at one side in the longitudinal direction and a handle 3b at the other side in the longitudinal direction. The rotary shaft 13 and the spring 12 are disposed between the holding end 3a and the handle 3b. The spring 12 biases or urges the lower movable wing 2 and the upper movable wing 3 in a direction in which the holding end 2a and the holding end 3a come close to each other. In the following explanation, a direction orthogonal to the longitudinal direction of the lower movable wing 2 and parallel to the rotary shaft 13 is defined as a left-right direction of the opening implement 100, and the left and right sides of the opening implement 100 are defined as the holding ends 2a and 3a are disposed on the near side (front side). A direction orthogonal to the longitudinal direction of the lower movable wing 2 and the left-right direction is defined as an up-down direction of the opening implement 100.

The elastic body (flexible member) 4 made of rubber and/or the like is attached to the vicinity of the holding end 2a of the lower movable wing 2. The recessed groove 5 is formed in the upper surface of the elastic body 4 in its longitudinal direction. The lower recessed hole 6 is formed at an end, of the elastic body 4, on the side of the holding end 2a. The upper recessed hole 7 is formed in the peripheral edge 14 of the holding end 3a of the upper movable wing 3 at a position corresponding to the lower recessed hole 6.

As depicted in FIG. 6, the clasp 8 includes the movable shaft (closing member) 9 movable inside the clasp 8 and the movable part 10 which is formed at a portion of the movable shaft 9. Further, the clasp 8 includes the fixed part 11 attached such that the fixed part 11 faces the movable port 10.

The effects of the opening implement 100 according to this embodiment will be summarized as follows.

The opening implement body 1 is formed of the upper movable wing 3 and the lower movable wing 2. Thus, people whose finger-tip strengths are low and elderly people can easily open a small catch or clasp of an accessory by using the opening implement 100. Further, since the opening implement body 1 includes the spring 12 in addition to the upper and lower movable wings 2, 3, even people whose finger-tip strengths are low can easily hold the clasp 8 with the opening implement 100. Furthermore, since the holding end 2a of the lower movable wing 2 is provided with the elastic body 4 such as rubber, people can hold the clasp 8 with the opening implement body 1 without suffering the slipping of the clasp 8. The lower recessed hole 6 and the recessed groove 5 formed in the elastic body 4 have the effect of reliably and firmly holding the fixed part 10 and the movable part 9 which face each other.

The opening implement 100 according to this embodiment brings the movable part 10 and the fixed part 11 of the clasp 8 closer to each other in such a manner that the holding end 3a of the upper movable wing 3 and the holding end 2a of the lower movable wing 2 are brought closer to each other by biasing force of the spring 12 in a state that the holding end 3a of the upper movable wing 3 holds the movable part 10 of the clasp 8 and that the holding end 2a of the lower movable wing 2 holds the fixed part 11 of the clasp 8. This moves the movable shaft 9 of the clasp 8 to open the clasp 8. Namely, a user of the opening implement 100 according to this embodiment can open and close the clasp 8 by simply moving the handle 2b of the lower movable wing 2 arid the handle 3b of the upper movable wing 3 of the opening implement 100. In other words, the user can open and close the clasp 8 without fingering the small movable part 10 and fixed part 11 of the clasp 8. The handle 2b, of the lower movable wing 2, which is formed integrally with the holding end 2a to move the holding end 2a extends along the upper movable wing 3 and the handle 3b of the upper movable wing 3 in a state of facing them, and the holding end 2a is brought closer to or is separated from the holding end 3a when the handle 2b moves relative to the upper movable wing 3 and the handle 3b while maintaining the state in which the handle 2b faces the upper movable wing 3 and the handle 3b. More specifically, the handle 2b of the lower movable wing 2 does not move linearly in the longitudinal direction of the upper movable wing 3, that is, the holding end 2a does not move linearly relative to the holding end 3a. The holding end 2a pivots about the rotary shaft 13 to approach or be separated from the holding end 3a, Similarly, the handle 3b, of the upper movable wing 3, which is formed integrally with the holding end 3a to move the holding end 3a extends along the lower movable wing 2 and the handle 2b of the lower movable wing 2 in a state of facing them, and the holding end 3a is brought closer to or is separated from the holding end 2a when the handle 3b moves relative to the lower movable wing 2 and the handle 2b while maintaining the state in which the handle 3b faces the lower movable wing 2 and the handle 2b. More specifically, the handle 3b of the upper movable wing 3 does not move linearly in the longitudinal direction of the lower movable wing 2, that is, the holding end 3a does not move linearly relative to the holding end 2a. The holding end 3a pivots about the rotary shaft 13 to approach or be separated from the holding end 2a.

The opening implement 100 according to this embodiment keeps the holding end 2a of the lower movable wing 2 and the holding end 3a of the upper movable wing 3 in the mutually approaching position with the biasing force of the spring 12, while no force is applied to the lower movable wing 2 and the upper movable wing 3 by the user. The opening implement 100 keeps the claps 8 in the open state accordingly. Once the user opens the clasp 8, the opening implement 100 according to this embodiment can keep the clasp 8 in the open state without requiring any force. The user, who has opened the clasp 8 to put on an accessory such as the necklace, then needs to make the necklace become a closed ring by connecting the clasp 8 with a part (for example, an unillustrated ring), of the necklace, formed at a position different from the position of the clasp 8 (for example, the other end of the necklace which is opposite to the end having the clasp 8). In order to make the necklace become the closed ring, the user needs to engage the unillustrated small ring or the like with the clasp 8 in the open state with concentration. The user of the opening implement 100 according to this embodiment can concentrate only on fitting the small ring or the like of the necklace in the narrow slit of the clasp 8 without putting his/her effort into holding the clasp 8 in the open state.

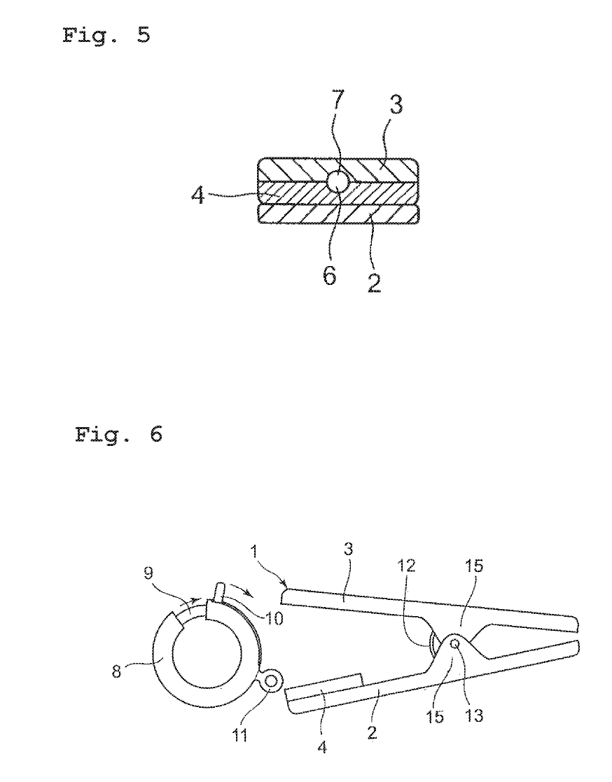

In this embodiment, as depicted in FIGS. 1 and 2, the elastic body 4 is attached to the vicinity of the holding end 2a of the lower movable wing 2, and the lower recessed hole 6 is formed at the end, of the elastic body 4, on the side of the holding end 2a (FIG. 5). A cross-section, of the lower recessed hole 6 cut in its depth direction, is a substantially semicircular shape. The lower movable wing 2 holds the fixed part 11 in a state that the fixed part 11 of the clasp 8 is fitted into the lower recessed hole 6 of the elastic body 4. Thus, the lower movable wing 2 according to this embodiment can hold the fixed part 11 stably while preventing the fixed part 11 from slipping in the left-right direction. Noted that, the holding end 2a and the elastic body 4 are not wire-like members, and hold the fixed part 11 while making surface contact with the fixed part 11.

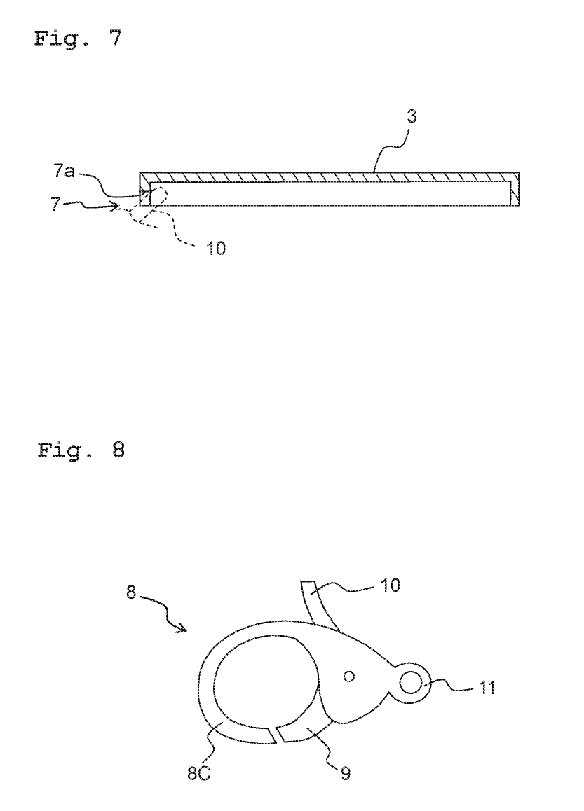

As depicted in FIGS. 1 and 3, the holding end 3a of the upper movable wing 3 of the opening implement 100 according to this embodiment includes the peripheral edge 14 (protruding portion) which protrudes from the outer edge of the upper moveable wing 3 toward the lower movable wing 2. The upper recessed hole 7 is formed at a part of the peripheral edge 14 (FIG. 5). A cross-section, of the upper recessed hole 7, cut in its depth direction is a substantially semicircular shape. As depicted in FIG. 7, an upper end 7a of the upper recessed hole 7 of the upper movable wing 3 presses the movable part 10 of the clasp 8 to slide the movable part 10 toward the fixed part 11. In this situation, the upper end 7a of the upper recessed hole 7 presses a side surface, of the movable part 10, positioned on the opposite side of the fixed part 11. This efficiently converts the biasing force of the spring 12 into the pressing force bringing the movable part 10 close to the fixed part 11. Further, the upper movable wing 3 presses the movable part 10 in a state that the movable part 10 is fitted into the upper recessed hole 7. This prevents the movable part 10 from slipping in the left-right direction. Note that, the holding end 3a is not a wire-like member and presses the movable part 10 without surrounding the movable part 10.

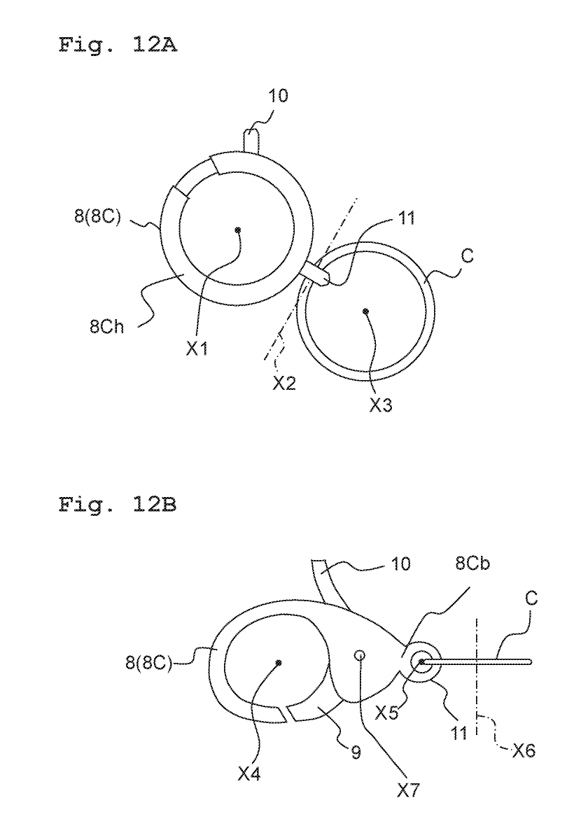

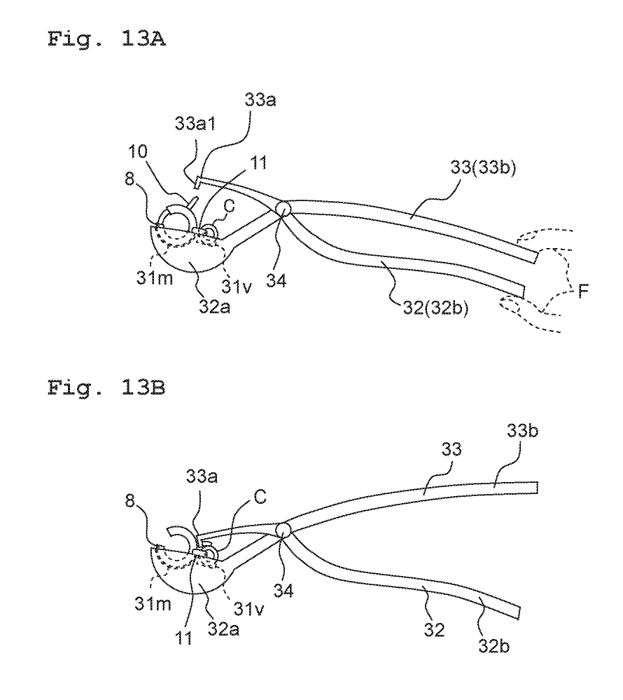

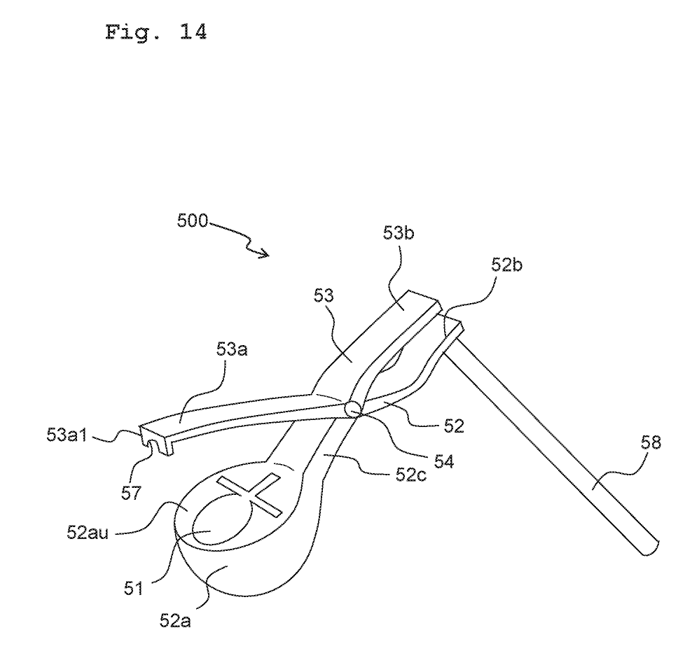

According to the opening implement 100 of this embodiment, the holding end 2a of the lower movable wing 2 can stably hold the fixed part 11 of the clasp 8 while preventing the fixed part 11 from slipping in the left-right direction, and the holding end 3a of the upper movable wing 3 can stably hold the movable part 10 of the clasp 8 while preventing the movable part 10 from slipping in the left-right direction. Therefore, the opening implement 100 according to this embodiment can hold and open the clasp 8 in a state that the clasp 8 has a standing posture with respect to the opening implement 100 (a state in which the clasp 8 is disposed along the up-down direction of the opening implement 100; a state in which a central axis X1 or X4 (FIG. 12A or 12B) of a ring 8C of a clasp 8 is positioned in a direction substantially orthogonal to the direction in which the holding ends 2a, 3a come closer to or are separated from each other; or a state in which the central axis X1 or X4 (FIG. 124 or 12B) of the ring 8C of the clasp 8 is positioned substantially parallel to the rotary shaft 13 of the opening implement 100).

Although the clasp 8 is depicted as a spring clasp in FIG. 6, the clasp 8 may be a lobster clasp depicted in FIG. 8. Similar to the spring clasp, the lobster clasp includes a movable shaft 9, a movable part 10, and a fixed part 11. When the lobster clasp is opened, the movable part 10 is allowed to approach the fixed part 11 to move the movable shaft 9 upwardly in FIG. 8. Each of the fixed part 11 (FIG. 6) of the spring clasp and the fixed part 11 (FIG. 8) of the lobster clasp has a ring, which is formed to connect an accessory body and each of the spring clasp and the lobster clasp. The clasp 8 is not limited to the above clasps, and may be any other part which includes the movable shaft 9, the movable part 10, and the fixed part 11 and can work in a similar manner as the spring clasp and the lobster clasp. In this embodiment, the holding end 2a of the lower movable wing 2 does not hold the ring 8C of the clasp 8, namely, the holding end 2a holds the fixed part 11 only. Thus, when the clasp 8 is the spring clasp, the opening implement 100 according to this embodiment can appropriately hold the clasp 8 by holding the fixed part 11 only, irrespective of the size of the ring 8C of the spring clasp. Further, the holding end 2a can appropriately hold the lobster clasp, the thickness of which is typically different from that of the spring clasp. The holding 2a can appropriately hold the clasp 8 (lobster clasp) by holding the fixed part 11 only, irrespective of the size of the lobster clasp.

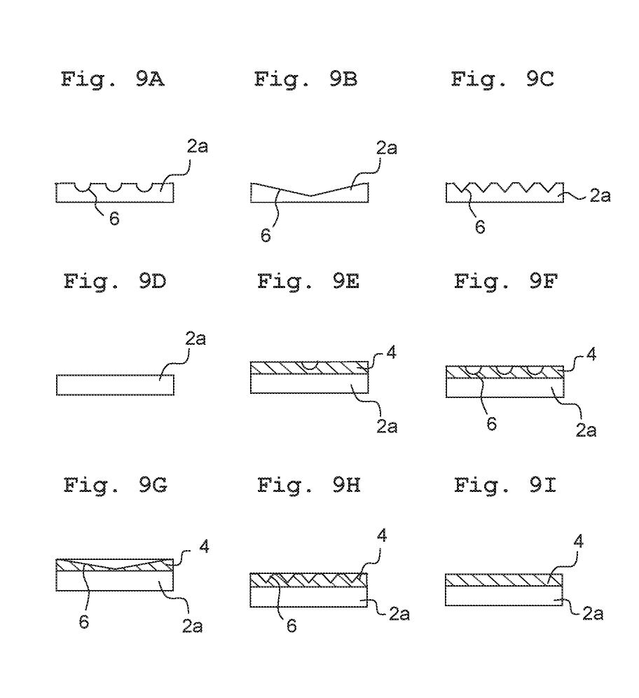

In the above embodiment, the holding end 2a may be shaped to hold not only the fixed part 11 but also the ring 8C. The holding end 2a of the lower movable wing 2 according to the above embodiment can be modified to have various forms. For example, the end, of the elastic body 4, on the side of the holding end 2a may include three lower recessed holes 6 (FIG. 9F), two lower recessed holes 6, or three or more lower recessed holes 6 in the left-right direction. The lower recessed hole 6 formed in the elastic body 4 may be a substantially V-shaped cutout, which inclines downward from both ends of the elastic body 4 in the left-right direction to the center (FIG. 9G). The elastic body 4 may include substantially V cutouts which are formed as the lower recessed holes 6 and disposed in the left-right direction. In such a case, any number of substantially V-shaped cutouts may be formed (FIG. 9H).

In the above embodiment, it is not indispensable to include the recessed groove 5. The elastic body 4 may be configured to have the lower recessed hole 6 only, without including the recessed groove 5. The elastic body 4 may be a structure in which neither the recessed groove 5 nor the lower recessed hole 6 is provided (FIG. 9I).

In the above embodiment, the elastic body 4 may not be attached to the holding end 2a of the lower movable wing 2. In this case, the holding end 2a may include, for example, three lower recessed holes 6, two or less lower recessed holes 6, or four or more lower recessed holes 6 (FIG. 9A). A cross-section, of each of the lower recessed holes 6, cut in its depth direction is a substantially semicircular shape. The lower recessed hole 6 formed in the holding end 2a may be a substantially V-shaped cutout, which inclines downward from both ends of the holding end 2a in the left-right direction to the center (FIG. 9B). The holding end 2a may include substantially V-shaped cutouts which are formed as the lower recessed holes 6 and disposed in the left-right direction (FIG. 9C). The holding end 2a may include the peripheral edge 14 only which protrudes from the holding end 2a, without including the lower recessed hole 6 (FIG. 9D).

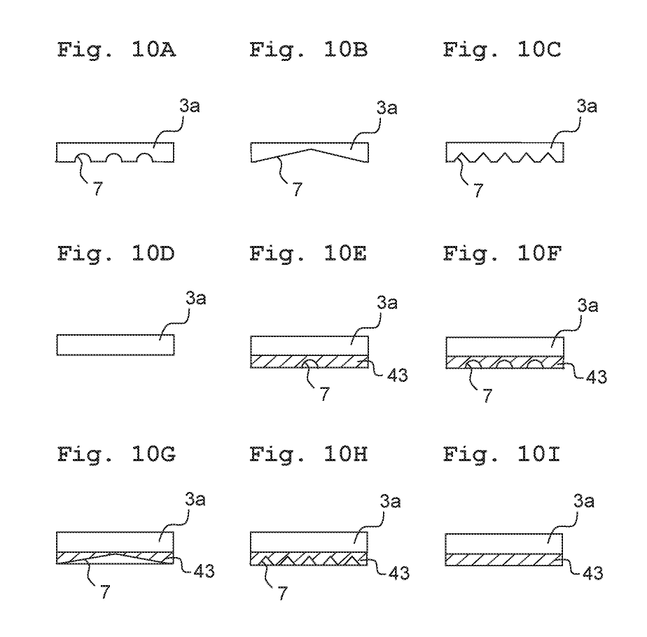

The holding end 3a of the upper movable wing 3 according to the above embodiment can be modified to have various forms. For example, the holding end 3a may include three upper recessed holes 7 (FIG. 10A), two upper recessed holes 7, or four or more upper recessed holes 7 in the left-right direction. The upper recessed hole 7 formed in the holding end 3a may be a substantially V-shaped cutout, which inclines upward from both ends of the holding end 3a in the left-right direction to the center (FIG. 10B). The holding end 3a may include substantially V-shaped cutouts which are formed as the upper recessed holes 7 and disposed in the left-right direction. In such a case, any number of substantially V-shaped cutouts may be formed (FIG. 10C). The holding end 3a may not include the upper recessed hole 7 (FIG. 10D).

In the above embodiment, an elastic body 43 may be attached to the holding end 3a of the upper movable wing 3. In this case, for example, the elastic body 43 may include the upper recessed hole 7 in its center in the left-right direction (FIG. 10E). A cross-section, of the upper recessed hole 7, cut in its depth direction is a substantially semicircular shape. The elastic body 43 may include three upper recessed holes 7 (FIG. 10F), two upper recessed holes 7, or four or more upper recessed holes 7 in the left-right direction. The upper recessed hole 7 formed in the elastic body 43 may be a substantially V-shaped cutout, which inclines upward from both ends of the elastic body 43 in the left-right direction to the center (FIG. 10G). The upper recessed hole 7 formed in the elastic body 43 may be substantially V-shaped cutouts which are disposed in the left-right direction (FIG. 10H). The elastic body 43 may not include the upper recessed hole 7.

Various effects can be obtained by combining each of the holding ends 2a described in the various modified examples with one of the holding ends 3a described in the various modified examples. For example, using the holding end 2a (FIG. 9F) having the elastic body 4 in which three lower recessed holes 6 are formed in the left-right direction and the holding end 3a (FIG. 10A) in which three upper recessed holes 7 are formed in the left-right direction enables easy holding of the clasp 8. The three lower recessed holes 6 and the three upper recessed holes 7 eliminate the need for disposing the clasp 8 in the almost center of the opening implement 100 in the left-right direction, namely they allow the user to easily engage one of the lower recessed holes 6 with the fixed part 11 and to easily engage one of the upper recessed holes 7 with the movable part 10. Note that the clasp 8 can also be held easily when the holding end 2a is replaced by the configuration which includes three lower recessed holes 6 directly formed in the holding end 2a (FIG. 9A) or the configuration which includes the V-shaped cutouts formed in the holding end 2a or the elastic body 4 (FIG. 9C or 9H), and/or when the holding end 3a is replaced by the configuration which includes three upper recessed holes 7 formed in the elastic body 43 (FIG. 10F) or the configuration which includes the V-shaped cutouts formed in the holding end 3a or the elastic body 43 (FIG. 10C or 10H).

As another example, using the holding end 2a (FIG. 9G) having the elastic body 4 in which the V-shaped cutout is formed as the lower recessed hole 6 and using the holding end 3a (FIG. 10B) in which the V-shaped cutout is formed as the upper recessed hole 7 enables easier holding of the clasp 8. This configuration has the V-shaped cutout as the lower recessed hole 6, and thus the fixed part 11 of the clasp 8 disposed at any position of the lower recessed hole 6 in the left-right direction is brought into contact with the lower recessed hole 6, slides on the surface of the lower recessed hole 6, and is guided to the center of the lower recessed hole 6 in the left-right direction. Similarly, this configuration has the V-shaped cutout as the upper recessed hole 7, and thus the movable part 10 of the clasp 8 disposed at any position of the upper recessed hole 7 in the left-right direction is brought into contact with the upper recessed hole 7, slides on the surface of the upper recessed hole 7, and is guided to the center of the upper recessed hole 7 in the left-right direction. According to this configuration, the user can appropriately open the clasp 8 at the center (deepest portion of each V-shaped cutout) of each of the recessed holes 6, 7 in the left-right direction and maintain the open state of the clasp 8 by simply disposing the clasp 8 at any position of each of the recessed holes 6, 7 in the left-right direction. Note that the clasp 8 can also be held easily when the holding end 2a is replaced by the configuration which includes, as the lower recessed hole 6, the V-shaped cutout directly formed in the holding end 2a (FIG. 9B) and/or when the holding end 3a is replaced by the configuration which includes, as the upper recessed hole 7, the V-shaped cutout formed in the elastic body 43 (FIG. 10G). Further, the holding end 2a and the holding end 3a may be any combination of each of the modified examples depicted in FIGS. 9A to 9I and one of the modified examples depicted in FIGS. 10A to 10I.

As the elastic bodies 4, 43, any flexible member such as silicone and rubber can be used. It is preferred that the flexible member have hardness which prevents the movable part 10 and fixed part 11 from sinking thereinto when the clasp 8 is opened, and a coefficient of static friction which prevents the movable part 10 and fixed part 11 from sliding in the left-right direction.

In the above embodiment, the spring 12 is a torsion spring disposed around the rotary shaft 13. The spring 12, however, is not limited to this and may have any structure such as a plate spring. The spring 12 may include an extension spring attached to a position between the holding end 2a of the lower movable wing 2 and the connection part 15 and attached to a position between the holding end 3a of the upper movable wing 3 and the connection part 15. The spring 12 may be a compression spring provided between the handle 2b of the lower movable wing 2 and the handle 3b of the upper movable wing 3. Each of the springs 12 described above can bias or urge the lower movable wing 2 and the upper movable wing 3 so that the holding end 2a and the holding end 3a come closer to each other.

In the above embodiment, the spring 12 biases the holding end 2a and the holding end 3a in the mutually approaching direction. The spring 12, however, may bias the holding end 2a and the holding end 3a in a mutually separating direction. The opening implement 100 having such a configuration also allows the user to open and close the clasp 8 by simply moving the handles 2h and 3b of the opening implement 100. In other words, the user can open and close the clasp 8 without fingering the small movable part 10 and fixed part 11 of the clasp 8.

In the above embodiment, when the lower movable wing 2 has no elastic body 4, it is preferred that the holding end 2a of the lower movable wing 2 be subjected to polishing treatment to prevent the damage of the fixed part 11 of the clasp 8 which would be otherwise caused by the contact with the holding end 2a. Similarly, when the upper movable wing 3 has no elastic body 43, it is preferred that the holding end 3a of the upper movable wing 3 be subjected to polishing treatment to prevent the damage of the movable part 10 of the clasp 8 which would be otherwise caused by the contact with the holding end 3a.

In the above embodiment, the upper surface of the upper movable wing 3 may include a mark indicating a position of the upper recessed hole 7. The user can easily engage the movable part 10 of the clasp 8 with the upper recessed hole 7 while visually confirming the mark. Alternatively, making at least a part of the holding end 3a of the upper movable wing 3 transparent enables easy engagement between the movable part 10 of the clasp 8 and the upper recessed hole 7.

### Second Embodiment

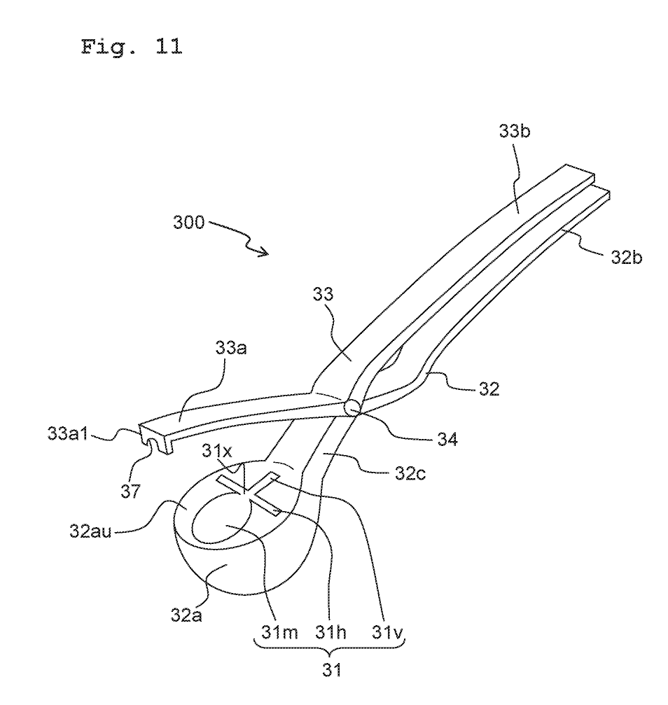

Subsequently, an explanation will be made about the second embodiment of the present disclosure with reference to FIGS. 11 to 13. An opening implement 300 according to the second embodiment is different from the opening implement 100 according to the first embodiment mainly in that a holding end 32a of a lower movable wing 32 includes a holding hole 31 which holds the clasp 8.

As depicted in FIG. 11, the opening implement 300 according to the second embodiment includes a lower movable wing 32 extending in a longitudinal direction (left-right direction of FIG. 11) and an upper movable wing 33 extending in the longitudinal direction. The lower movable wing 32 is connected integrally with the upper movable wing 33 via a rotary shaft 34. The lower movable wing 32 and the upper movable wing 33 can pivot about the rotary shaft 34.

One end of the lower movable wing 32 is the holding end 32a, and the other end, of the lower movable wing 32, including the vicinity thereof is a handle 32b. FIG. 11 depicts the holding end 32a on its left side and the handle 32b on its right side. The lower movable wing 32 includes a neck 32c between the holding end 32a and the handle 32b. The holding end 32a is substantially hemispherical and an upper surface 32au is inclined to an extending direction of the neck 32c by a predetermined angle.

The holding hole 31 is formed on the upper surface 32au of the holding end 32a. The holding hole 31 has a main hole 31m in a substantially elliptical shape, a longitudinal groove 31v in a substantially rectangular shape, and a lateral groove 31h in a substantially rectangular shape. The main hole 31m is substantially elliptic, and a principle axis direction of the main hole 31m is parallel to the longitudinal direction of the lower movable wing 32. The longitudinal groove 31v is connected to an end, of the main hole 31m, on the side of the neck 32c to extend in the principle axis direction of the main hole 31m. The lateral groove 31h is connected to the end, of the main hole 31m, on the side of the neck 32c to extend in the direction orthogonal to the principle axis direction of the main hole 31m.

The main hole 31m is a housing hole which houses a part of the clasp 8 to hold the clasp 8. The main hole 31m holds the clasp 8 by supporting the ring 8C of the clasp 8 from both sides in the direction of the central axis X1 or X4 (FIG. 12A or 12B), and thus the clasp 8 is held in astute that the clasp 8 has a standing posture with respect to the opening implement 300 (a state in which the clasp 8 is disposed along the up-down direction of the opening implement 300; notate in Which the central axis X1 or X4 (FIG. 12A or 12B) of the ring 8C of the clasp 8 is positioned in a direction substantially orthogonal to the direction in which the holding ends 32a, 33a come closer to or are separated from each other; or a state in which the central axis X1 or X4 (FIG. 12A or 12B) of the ring 8C of the clasp 8 is positioned parallel to the rotary shaft 34 of the opening implement 300). The opening implement 300 according to the second embodiment holds the clasp 8 with the main hole 31m, which allows the user to open the closing member 9 of the clasp 8 without holding the clasp 8 with the user's fingers. Further, the opening implement 300 according to the second embodiment holds the clasp 8 by housing the ring 8C of the clasp 8 in the main hole 31m. Therefore, the opening implement 300 according to the second embodiment can appropriately hold the clasp 8 with the main hole 31m, provided that the main hole 31m holds the clasp 8 in the standing posture with respect to the opening implement 300, irrespective of the structure or configuration of the clasp 8 (i.e., the clasp 8 may be the spring clasp, the lobster clasp, or any other structure) and irrespective of the size of the ring 8C of the spring clasp or the lobster clasp. When the clasp 8 is the spring clasp, the main hole 31m houses and holds a semi-circular part 8Ch (FIG. 12A). The semi-circular part 8Ch is a part of the ring 8C in an arc shape, has no movable part 10, and is positioned between the fixed part 11 and the movable shaft 9. When the clasp 8 is the lobster clasp, the main hole 31m houses and holds a base 8Cb (FIG. 12B). The base 8Cb is a part of the ring 8C and contains a pivotal shaft X7 of the movable shaft 9 and the movable part 10. The shape of the main hole 31m is not limited to the substantially elliptical shape, and can be adjusted appropriately so as to hold clasps 8 in various shapes and sizes in a state that each of the clasps 8 has the standing posture with respect to the opening implement 300. The longitudinal groove 31v holds a part of a round jumpring C (FIG. 12A) connected to the clasp 8 so that the round jumpring C is parallel to the clasp 8. The lateral groove 31h holds a part of the round jumpring C (FIG. 12B) connected to the clasp 8 so that the round jumpring C is perpendicular to the clasp 8.

When the clasp 8 is the spring clasp, the fixed part 11 is typically formed to have an approximately annular shape with a central axis X2 extending in the direction orthogonal to the central axis X1 of the ring 8C of the spring clasp, as depicted in FIG. 12A. Thus, the central axis X3 of the round jumpring C connected to the fixed part 11 is parallel to the central axis X1 of the ring 8C of the spring clasp. When the clasp 8 is the lobster spring, the fixed part 11 is typically formed to have an approximately annular shape with a central axis X5 extending in the direction parallel to the central axis X4 of the ring 8C of the lobster clasp, as depicted in FIG. 12B. Thus, the central axis X6 of the round jumpring C connected to the fixed part 11 is orthogonal to the central axis X4 of the ring 8C of the lobster clasp. Thus, the longitudinal groove 31v of the holding hole 31 is suitable for holding the round jumpring C connected to the spring clasp, and the lateral groove 31h is suitable for holding the round jumpring C connected to the lobster clasp. The uses of the grooves 31v, 31h, however, are not limited to the above.

One end of the upper movable wing 33 is the holding end 33a, and the other end, of the upper movable wing 33, including the vicinity thereof is a handle 33b. FIG. 11 depicts the holding end 33a on its left side and the handle 33b on its right side. The holding end 33a includes a folded part (thin plate) 33a1 which is folded toward the holding end 32a. The upper recessed hole 37 is formed in the folded part 33a1.

A plate spring not depicted) disposed in the vicinity of the rotary shaft 34 biases the lower movable wing 32 and the upper movable wing 33 so that the holding end 32a and the holding end 33a come closer to each other. Thus, the user can separate the holding end 32a and the holding end 33a by holding the handles 32h, 33b (FIG. 13A), and allows the holding end 32a and the holding end 33a to come close to each other by releasing the handles 32b, 33b (FIG. 13B). The handle 32b, of the lower movable wing 32, which is formed integrally with the holding end 32a to move the holding end 32a, extends along the upper movable wing 33 and the handle 33b of the upper movable wing 33 in a state of facing them, and the holding end 32a is brought closer to and is separated from the holding end 33a when the handle 32b moves relative to the upper movable wing 33 and the handle 33b while maintaining the state in which the handle 33b faces the upper movable wing 33 and the handle 33b. More specifically, the handle 32b of the lower movable wing 32 does not move linearly in the longitudinal direction of the upper movable wing 33, that is, the holding end 32a does not move linearly relative to the holding end 33a. The holding end 32a pivots about the rotary shaft 34 to approach or be separated from the holding end 33a. Similarly, the handle 33b, of the upper movable wing 33, which is formed integrally with the holding end 33a to move the holding end 33a, extends along the lower movable wing 32 and the handle 32b of the lower movable wing 32 in a state of facing them, and the holding end 33a is brought closer to or is separated from the holding end 32a when the handle 33b moves relative to the lower movable wing 32 and the handle 32b while maintaining the state in which the handle 33b faces the lower movable wing 32 and the handle 32b. More specifically, the handle 33b of the upper movable wing 33 does not move linearly in the longitudinal direction of the lower movable wing 32, that is, the holding end 33a does not move linearly relative to the holding end 32a. The holding end 33a pivots about the rotary shaft 34 to approach or be separated from the holding end 32a.

Subsequently, an explanation will be made about a method for using the opening implement 300 according to the second embodiment.

When the user opens the clasp 8, the user at first separates the holding end 32a and the holding end 33a by holding the handles 32b, 33b with fingers F, and then arranges the clasp 8 in the holding hole 31 (FIG. 13A). In particular, the user arranges the ring 8C of the spring clasp or the lobster clasp in the main hole 31m and arranges the round jumpring C connected to the spring clasp or the lobster clasp in the longitudinal groove 31v or the lateral groove 31h. In this situation, the fixed part 11 of the clasp 8 is held at an intersection 31x between the grooves 31v and 31h, and the round jumpring C is held at the longitudinal groove 31v or the lateral groove 31h. The central axis X1 or X4 of the ring 8C of the clasp 8 is positioned in a direction (direction parallel to the rotary shaft 34) substantially orthogonal to the direction in which the holding ends 32a, 33a come closer to or are separated from each other. The holding hole 31 may be configured to open the clasp 8 by holding any one of the fixed part 11 of the clasp 8 and the round jumpring C connected to the fixed part 11. Further, the holding hole 31 may include the main hole 31m only, namely the holding hole 31 may not include the grooves 31v, 31h. In this case, the fixed part 11 is held by the upper surface 32au of the holding end 32a at the periphery of the main hole 31m. That is, the upper surface 32au of the holding end 32a functions as a holding part holding the fixed part 11.

Subsequently, when the user weakens the force for holding the handles 32b, 33b to release them, the holding end 33a approaches the holding end 32a to engage the movable part 10 of the clasp 8 with the upper recessed hole 37 of the folded part 33a1. In this state, the folded part 33a1 presses a part, of the movable part 10, positioned on the opposite side of the fixed part 11 to slide the movable part 10 toward the fixed part 11 held at the intersection 31x between the grooves 31v and 31h, thereby opening the clasp 8 (FIG. 13B). Here, the user puts a ring or the like, of a necklace, through the clasp 8, the ring or the like being disposed at a position different from the clasp 8 (for example, the other end of the necklace which is opposite to the end having the clasp 8), and holds the handles 32b, 33b again with fingers to release the holding of the clasp 8. Accordingly, putting on the necklace has been completed.

According to the opening implement 300 in the second embodiment, the user can easily hold the clasp 8 by using the holding hole 31 and can easily open the clasp 8 by weakening the force for holding the handles 32b, 33b. Thus, the user of the opening implement 300 according to the second embodiment can obtain the similar effect as the opening. implement 100 according to the first embodiment, and further, the user of the opening implement 300 according to the second embodiment can obtain the effect of holding the clasp 8 more easily than the opening implement 100 according to the first embodiment.

Regarding the opening implement 300 in the second embodiment, the shape of the main hole 31m is not limited to the substantially elliptical shape, and the shape of the main hole 31m can be appropriately adjusted to hold various shapes and sizes of clasps 8, with the central axis X1 or X4 of the ring 8C of the clasp 8 being disposed in the direction (direction parallel to the rotary shaft 34) substantially orthogonal to the direction in which the holding ends 32a, 33a come closer to or are separated from each other. For example, it is preferred that the main hole 31m have a shape to support at least a half of the semi-circular part 8Ch of the clasp 8, which is the spring clasp, from both sides of the central axis X1; and it is more preferred that the main hole 31m have a shape to support about two-thirds of the semi-circular part 8Ch from both sides of the central axis X1. In addition to the above, it is preferred that the main hole 31m have a shape to support the almost entire area of an edge, of the base 8Cb of the clasp 8 formed as the lobster clasp, extending between the movable shaft 9 and the fixed part 11, from both sides of the central axis X4. Regarding the opening implement 300 in the second embodiment, the folded part 33a1 of the holding end 33a may not include the upper recessed hole 37. Further, the structure or configuration of the holding end 33a is not limited to the structure including a single upper recessed hole 37, and can have various modifications as depicted in FIGS. 10A to 10I, like the opening implement 100 according to the first embodiment.

The holding end 32a of the opening implement 300 according to the second embodiment may be made of any material including, for example, silicone and plastic. Further, the surface of the holding hole 31 may be coated with silicone or the like to let the holding hole 31 have a cushioning property. Furthermore, the holding hole 31 may have elasticity, thereby making it possible to appropriately hold more various shapes and sizes of clasps 8.

### Third Embodiment

Subsequently, an explanation will be made about the third embodiment of the present disclosure with reference to FIG. 14. An opening implement 500 according to the third embodiment is different from the opening implements 100, 300 according to the first and second embodiments in that the opening implement 500 includes a holding bar 58 connected to a lower movable wing 52.

As depicted in FIG. 14, the opening implement 500 according to the third embodiment includes the lower movable wing 52 extending in a longitudinal direction (left-right direction of FIG. 14) and an upper movable wing 53 extending in the longitudinal direction. The lower movable wing 52 is connected integrally with the upper movable wing 53 via a rotary shaft 54. The lower movable wing 52 and the upper movable wing 53 can pivot about the rotary shaft 54.

One end of the lower movable wing 52 is a holding end 52a, and the other end including the vicinity thereof is a handle 52b. FIG. 14 depicts the holding end 52a on its left side and the handle 52b on its right side. The lower movable wing 52 includes a neck 52c between the holding end 52a and the handle 52b. The holding end 52a is substantially hemispherical and an upper surface 52au is inclined to an extending direction of the neck 52c by a predetermined angle.

A holding hole 51 is formed in the upper surface 52au of the holding end 52a. The holding hole 51 has the same structure or configuration as that of the holding hole 31 of the opening implement 300 according to the second embodiment. The holding bar 58 is removably connected to the handle 52b in a state of being orthogonal to the longitudinal direction of the lower movable wing 52. The holding bar 58 has a cylindrical shape with a diameter of about 1 cm.

One end of the upper movable wing 53 is a holding end 53a, and the other end including the vicinity thereof is a handle 53b. FIG. 14 depicts the holding end 53a on its left side and the handle 53b on its right side. The holding end 53a has the same structure or configuration of that of the holding end 33a of the opening implement 300 according to the second embodiment. The holding end 53a includes a folded part 53a1 and an upper recessed hole 57.

A plate spring (not depicted) disposed in the vicinity of the rotary shaft 54 biases the lower movable wing 52 and the upper movable wing 53 so that the holding end 52a and the holding end 53a come closer to each other. Thus, the user can separate the holding end 52a and the holding end 53a by pressing the handle 53b with the user's thumb while holding the holding bar 58 (FIG. 14), and allows the holding ends 52a, 53a to conic close to each other by releasing the handle 53b. The handle 52b, of the lower movable wing 52, which is formed integrally with the holding end 52a to move the holding end 52a, extends along the upper movable wing 53 and the handle 53b of the upper movable wing 53 in a state of facing them, and the holding end 52a is brought closer to or is separated from the holding end 53a when the handle 52b moves relative to the upper movable wing 53 and the handle 53b while maintaining the state in which the handle 52b faces the upper movable wing 53 and the handle 53b. More specifically, the handle 52b of the lower movable wing 52 does not move linearly in the longitudinal direction of the upper movable wing 53, that is, the holding end 52a does not move linearly relative to the holding end 53a. The holding end 52a pivots about the rotary shaft 54 to approach or be separated from the holding end 53a, Similarly, the handle 53b, of the upper movable wing 53, which is formed integrally with the holding end 53a to move the holding end 53a, extends along the lower movable wing 52 and the handle 52b of the lower movable wing 52 in a state of facing them, and the holding end 53a is brought closer to or is separated from the holding end 52a, when the handle 53b moves relative to the lower movable wing 52 and the handle 52b while maintaining the state in which the handle 53b faces the lower movable wing 52 and the handle 52b. More specifically, the handle 53b of the upper movable wing 53 does not move linearly in the longitudinal direction of the lower movable wing 52, that is, the holding. end 53a does not move linearly relative to the holding end 52a. The holding end 53a pivots about the rotary shaft 54 to approach or be separated from the holding end 52a.

The method for opening the Clasp 8 by use of the opening implement 500 according to the third embodiment is the same as that by use of the opening implement 300 according to the second embodiment. The holding bar 58 of the opening implement 500 according to the third embodiment can be used, for example, when the user puts on a bracelet around the user's wrist.

When the user puts on the bracelet around the user's left wrist, the user at first holds the clasp 8 in the open state by the holding hole 51 and the holding end 53a of the opening implement 500. Next, the user arranges the holding end 52a on the user's left wrist while holding the tip of the holding bar 58 with finger(s) and palm of the user's left hand. Thus, the clasp 8 in the open state is stably arranged on the user's left wrist via the holding end 52a, the lower movable wing 52, and the holding bar 58. In this situation, the user engages a ring or the like, of the bracelet, disposed, for example, on the end of the bracelet which is opposite to the end having the clasp 8, with the clasp 8. Putting on the bracelet can be easily completed in this manner.

As another example, the holding bar 58 can be used also when the user puts on a necklace. If the user putting on the necklace holds the holding bar 58, the user can hold the opened clasp 8 near the user's neck without raising the user's arms to a high position, namely near the user's neck. This reduces the fatigue of the user's arms holding the opening implement 500, even when the user takes time to pass the ring or the like through the clasp 8, because the user does not need to keeps the user's arms holding the opening implement 500 at the high position.

The length of the holding bar 58 can be varied. For example, the holding bar 58 may have variable-length by using cylinders disposed telescopically. Further, the angle between the holding bar 58 and the lower movable wing 52 may be variable. The user can adjust the length of the holding bar 58 and the angle between the holding bar 58 and the lower movable wing 5 . thereby making it possible to hold the opened clasp 8 at any desired position. Although the holding bar 58 is removably connected to the lower movable wing 52 in the above embodiment, the holding bar 58 may be non-detachably or fixedly connected to the lower movable wing 52. Or, the holding bar 58 may be connected to the upper movable wing 53.

Each of the opening implements 100, 300 according to the first and second embodiments may include the holding bar 58 according to the third embodiment.

The holding ends 32a, 52a of the lower movable wings 32, 52 of the opening implements 300, 500 according to the second and third embodiments may be removably connected to the necks 32c, 52c, respectively. In this case, the holding end 32a may include a plurality of holding ends 32a having holding holes 31 in mutually different sizes and shapes, and the holding end 52a may include a plurality of holding ends 52a having holding holes 51 in mutually different sizes and shapes. Namely, the user selectively connects one of the holding ends 32a or one of the holding ends 52a to the necks 32c or 52c. Accordingly, the opening implements 300, 500 can be used for clasps 8 having various sizes and shapes.

Each of the opening implement 300 according to the second embodiment and the opening implement 500 according to the third embodiment may include an escape groove communicating with the holding holes 31 or 51. An accessory body, such as a necklace, which is connected to the round jumpring C held by the holding holes 31 or 51 is placed in the escape groove to prevent the contact between the accessory body and the upper movable wings 33 or 53. This allows the clasp 8 to be opened more appropriately.

Regarding each of the opening implement 300 according to the second embodiment and the opening implement 500 according to the third embodiment, the plate spring biases or urges the holding ends 32a or 52a and the holding ends 33a or 53a in the mutually approaching direction. The present disclosure, however, is not limited to this. Similar o the opening implement 100 according to the first embodiment, various configurations including the torsion spring, the extension spring, the compression spring, and the like can bias or urge the holding ends 32a or 52a and the holding ends 33a or 53a in the mutually approaching direction in each of the opening implement 300 according to the second embodiment and the opening implement 500 according to the third embodiment.

Regarding each of the opening implement 300 according to the second embodiment and the opening implement 500 according to the third embodiment, the plate spring (biasing member) biases or urges the holding ends 32a or 52a and the holding ends 33a or 53a in the mutually approaching direction. The biasing member such as the plate spring, however, may bias the holding ends 32a or 52a and the holding ends 33a or 53a in the mutually separating direction. The user can open and close the clasp 8 with the opening implements 300 or 500 having such a biasing member by simply moving the handles 32b or 52b of the lower movable wings 32 or 52 and the handles 33b or 53b of the upper movable wings 33 or 53. In other words, the user can open and close the clasp 8 without fingering the small movable part 10 and fixed part 11 of the clasp 8.

Each of the opening implement 100 according to the first embodiment, the opening implement 300 according to the second embodiment, and the opening implement 500 according to the third embodiment may include an integrally-formed loupe or an attaching part to which the loupe is attached. Since the user engages the clasp 8 with the ring by handling the opening implement with both hands so as to put on the accessory, it is difficult for the user to use the loupe when engaging the clasp 8 with the ring. However, if such opening implement is used, the user can visually confirm the clasp 8 via the loupe while holding such opening implement only. Namely, the loupe enables the user to see the magnified clasp 8 and ring, thereby making it possible for the user to easily engage the clasp 8 with the ring.

Regarding each of the opening implement 100 according to the first embodiment, the opening implement 300 according to the second embodiment, and the opening implement 500 according to the third embodiment, the biasing member, such as the spring 12, which biases the holding ends 22a, 32a or 52a and the holding ends 3a, 33a or 53a in the mutually approaching direction, may include a locking mechanism killing the biasing force. The opening implement having the locking mechanism can maintain the state, in which the holding ends 2a, 32a, or 52a is separated from the holding ends 3a, 33a, or 53a by means of the locking mechanism, and thus the fixed part 11 of the clasp 8 can be held by the holding ends 2a, 32a, or 52a more easily, and the movable part 10 can be held by the holding ends 3a, 33a, or 53a more easily. It is preferred that the locking mechanism release the locking state by simply applying the pressing force to the handles 2b, 32b, or 52b and the handles 3b, 33b, or 53b.

Although the opening implements which can be used for both the spring clasp and the lobster clasp have been cited as examples in the above embodiments, each of the opening implements may have a modified configuration so that the opening implement specializes in the spring clasp, the lobster clasp, or an accessory clasp or catch similar to any of them. The present invention is not limited to the above embodiments provided that the characteristics of the present invention can be obtained. The present invention includes any other embodiments which can be conceived in the range of the technical ideas of the present invention.

According to the opening implement of the above embodiments, a user is not required to directly handle the small movable part and fixed part of the ring-shaped clasp of the accessory. Namely, the user can easily open the ring-shaped clasp of the accessory by simply operating the opening implement to bring the first holding part and the second holding part of the opening implement close to each other.

In the opening implement according to the above embodiments, the predetermined direction may be a direction in which the first holding part and the second holding part come close to each other. When this opening implement is used, and the ring-shaped clasp of the accessory are opened, the user can maintain the open state of the ring-shaped clasp of the accessory without applying any force, thereby making it possible to easily put the accessory around a part of the user's body.

In the opening implement according to the above embodiments, the second holding part may include a projection projecting toward the first holding part, and the biasing member may allow the movable part and the fixed part to come close to each other by pressing a part, of the movable part, positioned on a side opposite to the fixed part with the projection. Such an opening implement can more efficiently convert the force which is applied by the biasing member or the user to move the first and second holding parts close to each other, into the force bringing the movable part close to the fixed part. This allows the user to open the ring-shaped clasp of the accessory with weaker force.

The opening implement according to the above embodiments may further include a first handle fixed to the first holding part and a second handle fixed to the second holding part. The connection part may be a rotary shaft being disposed at a position between the first holding part and the first handle and between the second holding end and the second handle, and pivotably connecting the second holding part to the first holding part. The second holding part may approach the first holding part by pivoting about the rotary shaft. In the opening implement according to the above embodiments, the projection of the second holding part may have a plate shape, and the second holding part may include a recessed hole formed in the plate-shaped projection. The first holding part may include a flexible member. The flexible member may include a recessed hole configured to hold the fixed part. Such an opening implement can more efficiently convert the force which is applied by the biasing member or the user to move the first and second holding parts close to each other, into the force bringing the movable part close to the fixed part, and such an opening implement can hold the opened ring-shaped clasp of the accessory in the state which is appropriate for putting on the accessory.

The first holding part may include a housing hole configured to house a semi-circular part, of a spring clasp, which is defined between the fixed part and the closing member and in which the movable part does not exist, or a base, of a lobster clasp, which contains a pivotal shaft of the closing member and the movable part. The user can hold the fixed part more easily by the first holding part of the opening implement having the above configuration. The opening implement according to the above embodiments may further include a holding bar connected to any one of the first handle and the second handle, wherein, in a case that a user puts a bracelet around the user's wrist, the user may hold the holding bar to arrange the ring-shaped clasp of the bracelet which is in the open state by being held by the first holding part and the second holding part, adjacent to the user's wrist around which the bracelet is to be put. Although the user putting the bracelet around his/her wrist can use only one hand, the user can easily put the bracelet around the user's wrist by using such an opening implement.

According to a second aspect of the present disclosure, there is provided an opening implement for a necklace clasp characterized in that an opening implement body has a construction in which a lower movable wing and an upper movable wing are freely opened and closed by a spring, an elastic body is attached to an end of the lower movable wing, a lower recessed hole and a recessed groove are formed on the elastic body toward the end, an upper recessed hole corresponding to the lower recessed hole is formed on an peripheral edge of an end of the upper movable wing. The opening implement according to the second aspect can obtain the same effect as the opening implement according to the first aspect.

Since the opening implement according to the embodiments has the configuration described above, it can open the catch or clasp easily.

One aspect of the present disclosure can provide an opening implement which allows everyone to easily open a clasp or catch of an accessory such as a necklace, regardless of finger-tip strength, the length of a nail, eye sight, and the like.

1. An opening implement for a ring-shaped clasp of an accessory, the clasp including: a body having a cutout part which allows a part of a linear accessory, to be used by being put around a part of a human body, to pass; a closing member configured to close the cutout part; a movable part connected to the closing member to open and close the closing member; and a fixed part through which another part of the linear accessory is passed, the opening implement comprising:
a first holding part configured to hold the fixed part;
a second holding part configured to hold the movable part; and
a connecting part connecting the first holding part and the second holding part so that the second holding part is movable relative to the first holding part;
wherein the movable part held by the second holding part and the fixed part held by the first holding part are allowed to come close to each other to open the ring-shaped clasp of the accessory,
the ring-shaped clasp of the accessory is a spring clasp or a lobster clasp,
the first holding part includes a housing part configured to house any of a part of the s ring clasp and a part of the lobster clasp, and
any of the spring clasp and the lobster clasp is held by only the first holding part via the housing part.

2. The opening implement according to claim 1, wherein the housing part is a housing hole,
in a case that the ring-shaped clasp of the accessory is the spring clasp, the housing hole houses a semi-circular part, of the spring clasp, which is defined between the fixed part and the closing member and in which the movable part does not exist,
in a case that the ring-shaped clasp of the accessory is the lobster clasp, the housing hole houses a base, of the lobster clasp, which contains a pivotal shaft of the closing member and the movable part, and
an edge of the housing hole holds the fixed part.

3. The opening implement according to claim I, wherein the housing part includes a housing hole, a first groove configured to house a circular ring connected to the fixed part of the spring clasp, and a second groove configured to house a circular ring connected to the fixed part of the lobster clasp,
the housing hole is connected with the first groove and the second groove, and
the first groove and the second groove are perpendicular to each other.

4. The opening implement according to claim 3, wherein in a case that the ring-shaped clasp of the accessory is the spring clasp, the housing hole houses a semi-circular part, of the spring clasp, which is defined between the fixed part and the closing member and in which the movable part does not exist,
in a case that the ring-shaped clasp of the accessory is the lobster clasp, the housing hole houses a base, of the lobster clasp, which contains a pivotal shaft of the closing member and the movable part, and
an intersection between the first groove and the second groove holds the fixed part.

5. The opening implement according to claim 2, wherein the housing hole holds at least half of the semi-circular part in a case that the ring-shaped clasp of the accessory is the spring clasp.

6. The opening implement according to claim 1, wherein the first holding part further includes a groove which is connected to the housing part, and in which a part of the linear accessory connected to the ring-shaped clasp of the accessory is placed in a case that the housing part houses the ring-shaped clasp of the accessory.

7. The opening implement according to claim 1, further comprising a biasing member configured to bias the first holding part and the second holding part to be closer to each other.

8. The opening implement according to claim 1, wherein the second holding part includes a projection projecting toward the first holding part; and
the movable part and the fixed part are brought closer to each other by pressing a part, of the movable part, positioned on a side opposite to the fixed part with the projection.

9. The opening implement according to claim 8, wherein the projection has a plate shape, and the second holding part includes a recessed hole formed in the plate shaped projection.

10. The opening implement according to claim 1, further comprising a first handle connected to the first holding part and a second handle connected to the second holding part, wherein a holding bar is connected to the first handle or the second handle.
